(19) United States
(12) Patent Application Publication
(10) Pub. No.: US 2008/0203144 A1
(43) Pub. Date: Aug. 28, 2008

(54) Artificial Intelligence Shoe Mounting a Controller and Method for Measuring Quantity of Motion

(75) Inventor: Hee-Suk Kim, Kyungsangnam-do (KR)

Correspondence Address: RABIN & Berdo, PC, 1101 14TH STREET, NW, SUITE 500, WASHINGTON, DC, 20005, US

(73) Assignee: AISON CO., LTD., Busan (KR)

(21) Appl. No.: 11/994,102

(22) PCT Filed: Sep. 26, 2006
(86) PCT No.: PCT/KR06/03829

§ 371 Date: Dec. 27, 2007

(30) Foreign Application Priority Data
May 30, 2006 (KR) 10-2006-0049025

(51) Int. Cl. G01C 22/00; G01C 21/00; G01F 15/06; A43B 23/00

(52) U.S. Cl. 235/105; 377/24.2; 377/19; 36/136

(57) ABSTRACT

The present invention relates, in general, to shoes for measuring the quantity of motion and a method of measuring the quantity of motion using the shoes and, more particularly, to artificial intelligence shoes, in which various numerical values (calorie consumption, body fat, and a pulse), measured by a walking sensor (23), a body fat measurement unit, and a pulse sensor (21) mounted in a shoe body, are displayed in real time on a display unit (32), so that a user can periodically check his or her quantity of motion, and in which calorie consumption and body fat are calculated on the basis of the user's body conditions, so that the precision thereof is high, and such quantity of motion numerical values can be transmitted to various types of external devices, thus enabling the user to periodically manage the quantity of motion thereof.

### TECHNICAL FIELD

The present invention relates, in general, to shoes and method for measuring a quantity of motion and, more particularly, to artificial intelligence shoes and method for measuring the quantity of motion, in which various numerical values (calorie consumption, body fat, and pulse), measured by a walking sensor, a body fat measurement unit, and a pulse sensor which are mounted in a shoe body, are displayed on a display unit in real time, so that a user can periodically check his or her quantity of motion, thus the shoes and method are useful in the management of the user's health, and in which the calorie consumption and the body fat are calculated on the basis of the user's body conditions (height, weight, age, gender, shoe weight), so that the precision thereof is high, and such calculated information can be transmitted to various types of external devices (personal computer, mobile phone, and portable memory), thus allowing the user to periodically manage the quantity of his/her motion.

### BACKGROUND ART

Since modern people do not get sufficient exercise due to their busy schedules but frequently eat high calorie-food in their abundant lives, various types of fat accumulate in their bodies, which results in corpulence, thus the modern people are exposed to the risk of various types of geriatric diseases. Therefore, even if they intend to set aside time to exercise, it is difficult in practice to honor this intention due to their busy schedules.

Therefore, shoes for measuring the quantity of motion, which are capable of checking the quantity of motion, have been developed in consideration of the life pattern of modern people. A representative example of the shoes was disclosed in Korean Utility Model Registration No. 333954 (registered on Nov. 11, 2003). Such shoes adopt a scheme for transmitting signals, generated by signal generation units respectively installed in both shoes, to a portable terminal, such as a stopwatch, in a wireless manner, and for causing a user to check the quantity of motion through the portable terminal. Accordingly, the conventional shoes not only make it difficult to precisely check the quantity of motion because data loss and distortion occur during a wireless transmission/reception procedure, but are also inconvenient in that the portable terminal must always be carried. Further, in order to calculate a step, signal generation units must be provided in both shoes, thus there is a problem in that the production cost and maintenance cost of the shoes are increased.

Meanwhile, since the above-described prior art is developed on the basis of only the checking of calorie consumption, among various types of motion quantities, the user cannot check his or her current body fat and determine whether the user is fat, so that efficient management of body fat is difficult. Further, if the user takes excessive exercise, overstrain is applied to the heart, and a heartbeat becomes abnormally rapid. In the prior art, since the user must feel his or her heart condition, and control the level of exercise, the case where the user may die due to acute myocardial infarction or heart failure frequently occurs if the user continues to exercise despite overstrain being applied to the heart.

### DISCLOSURE OF INVENTION

### Technical Problem

Accordingly, the present invention has been made keeping in mind the above problems occurring in the prior art, and an object of the present invention is to provide artificial intelligence shoes, in which a display unit is provided in a controller attached to one shoe, so that a user can check his or her calorie consumption, etc. anytime without carrying a separate terminal, and a method of measuring the quantity of motion.

Another object of the present invention is to provide artificial intelligence shoes, in which a controller attached to one shoe can be attached to or detached from the shoe, so that the controller can be prevented from being damaged when the shoe is cleaned, and can be easily repaired or replaced when the controller breaks down, and a method of measuring the quantity of motion.

A further object of the present invention is to provide artificial intelligence shoes, in which body fat can be monitored in real time anytime, thus allowing a user to check his or her fat state anytime, and a method of measuring the quantity of motion.

Yet another object of the present invention is to provide artificial intelligence shoes, in which a pulse can be checked anytime, so that a user can visually monitor his or her current heart condition, thus preventing accidental death caused by excessive exercise, and a method of measuring the quantity of motion.

Still another object of the present invention is to provide artificial intelligence shoes, which allow a user to personally input his or her height, age, weight, gender, and shoe weight, so that the user can determine his or her optimal calorie consumption, etc., thus maximizing the effect of exercise, and a method of measuring the quantity of motion.

Still another object of the present invention is to provide artificial intelligence shoes, for which insertable midsoles, having different weights and heights, are provided in order to vary the height and weight of a user, so that required calorie consumption can be arbitrarily adjusted, thus improving the effect of exercise, and a method of measuring the quantity of motion.

Still another object of the present invention is to provide artificial intelligence shoes, which can store data about the calorie consumption, body fat and pulse of users in a controller, and transmit such data to a portable terminal or a mobile phone in a wired/wireless manner, and a method of measuring the quantity of motion.

Still another object of the present invention is to provide artificial intelligence shoes, which compare data about measured calorie consumption, body fat and pulse with reference data and provide an audible or visual alarm with respect to whether the quantity of motion per day has been achieved, whether excessive body fat is present, and whether an abnormality has occurred in the heart, thus calling the user's attention thereto, and a method of measuring the quantity of motion.

Still another object of the present invention is to provide artificial intelligence shoes, in which a controller is installed in either of the two shoes, thus improving the convenience of use of the artificial intelligence shoes, decreasing the production cost thereof, and further facilitating the maintenance thereof, and a method of measuring the quantity of motion.

### Technical Solution

The present invention is implemented according to embodiments having the following constructions to accomplish the above objects.

According to a first embodiment of the present invention, there is provided Artificial intelligence shoes, comprising a walking sensor embedded in one of the shoes to sense whether a user is walking; and a controller for receiving a signal from the walking sensor, and calculating calorie consumption, wherein the walking sensor periodically generates ON/OFF signals when the shoe lands on a ground and when the shoe leaves the ground, depending on walking of the user, and wherein the controller is detachably attached to the shoe, and comprises a body fat measurement unit provided with conductive contact electrodes for causing current to flow into a body of the user in order to measure the user's body fat, and a display unit for displaying calorie consumption calculated based on a walking speed, derived from a temporal difference, which is calculated for the ON/OFF signals received from the walking sensor, and a measured body fat calculated by the body fat measurement unit.

According to a second embodiment of the present invention, the artificial intelligence shoes according to the first embodiment further comprise a pulse sensor for measuring a pulse of the user, wherein the controller receives a signal measured by the pulse sensor and additionally calculates the user's pulse, and the display unit additionally displays the calculated pulse.

According to a third embodiment of the present invention, in the artificial intelligence shoes according to the first or second embodiment, the controller further comprises an input unit for inputting physical information about the user, a central processing unit for calculating and processing various types of information, and memory for storing various types of information.

According to a fourth embodiment of the present invention, in the artificial intelligence shoes according to the third embodiment, the controller further comprises a light emitting unit for variously emitting light with respect to a case where the user has taken insufficient exercise, or a case where an abnormality occurs in a heart of the user.

According to a fifth embodiment of the present invention, in the artificial intelligence shoes according to the third embodiment, the controller further comprises an alarm unit for providing an audible alarm with respect to a case where the user has taken insufficient exercise, or a case where an abnormality occurs in a heart of the user.

According to a sixth embodiment of the present invention, in the artificial intelligence shoes according to the third embodiment, the controller further comprises a transmission unit for transmitting various types of information to an external device.

According to a seventh embodiment of the present invention, in the artificial intelligence shoes according to the sixth embodiment, the transmission unit comprises at least one of a wired transmission unit, a wireless transmission unit, and an external memory interface unit.

According to an eighth embodiment of the present invention, in the artificial intelligence shoes according to the third embodiment, the input unit is implemented to enable input of at least one of the user's age, gender, height and weight.

According to a ninth embodiment of the present invention, in the artificial intelligence shoes according to the third embodiment, the controller further comprises a walking sensing circuit unit for eliminating noise from a signal received from the walking sensor and amplifying a noise-eliminated signal.

According to a tenth embodiment of the present invention, in the artificial intelligence shoes according to the third embodiment, the controller further comprises a pulse sensing circuit unit for eliminating noise from a signal received from the pulse sensor and amplifying a noise-eliminated signal.

According to an eleventh embodiment of the present invention, in the artificial intelligence shoes according to the first or second embodiment, the body fat measurement unit further comprises a body fat sensing circuit unit for generating a predetermined oscillation signal, transmitting the oscillation signal to a conductive contact electrode on a first side, and transmitting a signal, which flows from the conductive contact electrode on the first side into a conductive contact electrode on a second side through a human body, to the central processing unit.

According to a twelfth second embodiment of the present invention, in the artificial intelligence shoes according to the first or second embodiment, the walking sensor is embedded in either of two shoes.

According to a thirteenth embodiment of the present invention, in the artificial intelligence shoes according to the twelfth embodiment, the walking sensor is a metal contact switch.

According to a fourteenth embodiment of the present invention, in the artificial intelligence shoes according to the second embodiment, the pulse sensor is inserted into at least one of a portion of the shoe corresponding to the Achilles' tendon of the user, and a portion of the shoe corresponding to a top side of a foot of the user.

According to a fifteenth embodiment of the present invention, in the artificial intelligence shoes according to the fourteenth embodiment, the pulse sensor is any one of a piezoelectric sensor for converting a minute pulse of an artery into a fine voltage, and an optical sensor for radiating light onto blood in an artery and thus sensing a pulse.

According to a sixteenth embodiment of the present invention, in the artificial intelligence shoes according to the first or second embodiment, the controller is detachably attached to a controller case embedded in a predetermined location in the shoe.

According to a seventeenth embodiment of the present invention, in the artificial intelligence shoes according to the sixteenth embodiment, the controller case is a box-shaped member having a first open side and a second closed side and having a first fitting recess on a side thereof, and the controller comprises a first fitting protrusion on an outer circumference thereof, so that the first fitting protrusion is fitted into the first fitting recess, thus firmly supporting the controller.

According to an eighteenth embodiment of the present invention, in the artificial intelligence shoes according to the seventeenth embodiment, the controller case comprises a second fitting recess on a bottom thereof, and the controller comprises a second fitting protrusion on a rear surface thereof, so that the second fitting protrusion is fitted into the second fitting recess, thus firmly supporting the controller.

According to a nineteenth embodiment of the present invention, in the artificial intelligence shoes according to the sixteenth embodiment, the controller comprises terminals and the controller case comprises opposite terminals, the opposite terminals of the controller case being electrically conducted to the walking sensor or the pulse sensor, and the terminals of the controller being electrically connected to the opposite terminals of the controller case to receive signals from the opposite terminals.

According to a twentieth embodiment of the present invention, in the artificial intelligence shoes according to the first or second embodiment, the controller is detachably attached to any one of a side surface of a midsole of the shoe, an insole of the shoe, a region covering the midsole and an upper of the shoe, a region covering an outsole, the midsole and the upper of the shoe, and a bottom of the outsole of the shoe.

According to a twenty first embodiment of the present invention, the artificial intelligence shoes according to the first or second embodiment further comprise a detachable insole and midsole, wherein the detachable insole or midsole can be inserted into the shoe, and the insole and midsole form a set for each weight in order to control a quantity of motion of the user depending on a weight of the insole or midsole.

According to a twenty second embodiment of the present invention, the artificial intelligence shoes according to the first or second embodiment further comprise a detachable insole and midsole, wherein the detachable insole or midsole can be inserted into the shoe, and the insole and midsole form a set for each height in order to control a quantity of motion of the user depending on a height of a heel of the insole or midsole.

According to a twenty third embodiment of the present invention, in the artificial intelligence shoes according to the first or second embodiment further comprise a detachable insole and midsole, wherein the midsole comprises a top air-containing depression formed on a top of a heel thereof, a plurality of through holes penetrated to be spaced apart from the air-containing depression by a predetermined distance, top flow paths for connecting the through holes to the top air-containing depression, a bottom air-containing depression formed on a bottom of the midsole, and bottom flow paths for connecting the bottom air-containing depression to the through holes.

According to a twenty fourth embodiment of the present invention, in the artificial intelligence shoes according to the twenty third embodiment, the through holes are holes penetrating through the bottom and top of the midsole, each of the through holes on the bottom having an inlet which is formed in a frustoconical shape.

According to a twenty fifth embodiment of the present invention, the artificial intelligence shoes according to the first or second embodiment further comprise a detachable insole and midsole, wherein the insole has a surface to which silver yarn fabric is adhered, thus imparting an antibiotic property to the insole.

According to a twenty sixth embodiment of the present invention, the artificial intelligence shoes according to the first or second embodiment further comprise a detachable insole and midsole, wherein the insole comprises an antibacterial layer formed by applying silver nano liquid on the insole.

According to a twenty seventh embodiment of the present invention, the artificial intelligence shoes according to the first or second embodiment further comprise a detachable insole and midsole, wherein the insole comprises an antibacterial layer formed by applying ceramic negative ions or vitamin c, or by applying a liquid mixture of the ceramic negative ions and vitamin c.

According to a twenty eighth embodiment of the present invention, the artificial intelligence shoes according to the first or second embodiment further comprise a detachable insole and midsole, wherein the midsole comprises an antibacterial layer formed by applying silver nano liquid on the midsole.

According to a twenty ninth embodiment of the present invention, the artificial intelligence shoes according to the first or second embodiment further comprise a detachable insole and midsole, wherein the midsole comprises an antibacterial layer formed by applying ceramic negative ions or vitamin c, or by applying a liquid mixture of the ceramic negative ions and vitamin c.

According to a thirtieth embodiment of the present invention, the artificial intelligence shoes according to the first or second embodiment further comprise a detachable insole and midsole, wherein the midsole comprises an impact absorption unit formed on a heel thereof to absorb an impact of a load when landing.

According to a thirty first embodiment of the present invention, the artificial intelligence shoes according to any of the first, second and thirtieth embodiments further comprise a detachable insole and midsole, wherein the midsole comprises a loop part formed on a portion of a heel thereof to enable a finger to be inserted thereinto.

According to a thirty second embodiment of the present invention, the artificial intelligence shoes according to the first or second embodiment further comprise a weight sensor for automatically sensing a weight of the user or a weight of the shoe.

According to a thirty third embodiment of the present invention, in the artificial intelligence shoes according to the first or second embodiment, the controller comprises a power cutoff unit for sensing motion of the user and automatically cutting off power of the controller if no motion is sensed, thus preventing consumption of battery power.

According to a thirty fourth embodiment of the present invention, in the artificial intelligence shoes according to the first or second embodiment, the display unit of the controller further comprises a backlight unit for emitting light.

According to a thirty fifth embodiment of the present invention, in the artificial intelligence shoes according to the eighth embodiment, the input unit of the controller additionally inputs a weight of the user's shoe.

According to a thirty sixth embodiment of the present invention, there is provided a method of measuring a quantity of motion, comprising a walking sensing step of a walking sensor, which is included in one of the artificial intelligence shoes disclosed in the first or second embodiment, periodically generating ON/OFF signals when the artificial intelligence shoe lands on a ground and when the artificial intelligence shoe leaves the ground; a body fat measuring step of a body fat measurement unit measuring body fat by causing an electric current to flow through a body of a user, using conductive contact electrodes which cause an electric current to flow through the body; a calculating step of receiving signals generated by the walking sensor and the body fat measurement unit, and calculating calorie consumption and body fat; and a display step of displaying the calculated calorie consumption and the calculated body fat on the display unit of the controller, wherein the calculating step is performed to calculate calorie consumption depending on a walking speed, which is derived by calculating a temporal difference between a landing time point and a subsequent landing time point at the walking sensing step.

According to a thirty seventh embodiment of the present invention, the method according to the thirty sixth embodiment further comprises a pulse sensing step of a pulse sensor, embedded in the shoe, sensing a pulse of the human body, wherein the calculating step is performed to receive a signal generated by the pulse sensor and to additionally calculate a pulse, and the display step is performed to additionally display the pulse on the display unit of the controller.

According to a thirty eighth embodiment of the present invention, the method according to the thirty sixth or thirty seventh embodiment further comprises a step coefficient table storing step of defining statistical values of steps for respective heights of persons as step coefficients, and storing a step coefficient table, in which the step coefficients are arranged as a table, in memory; and a reference calorie table storing step of storing a reference calorie table, in which calorie coefficients per minute per kg according to speed per step are arranged as a table, in memory, wherein the calculating step is performed to calculate a temporal difference between a landing time point and a subsequent landing time point at the walking sensing step, calculate a speed using the step coefficient table, a step designated by a height of the user, and the temporal difference, and find a calorie coefficient per minute corresponding to the speed in the reference calorie table, thus calculating measured calorie consumption.

According to a thirty ninth embodiment of the present invention, the method according to the thirty sixth or thirty seventh embodiment further comprises a user information inputting step for inputting at least one of the user's age, gender, height and weight, wherein the calculating step is performed to calculate measured calorie consumption or measured body fat using the user information.

According to a fortieth embodiment of the present invention, the method according to the thirty sixth or thirty seventh embodiment further comprises an alarming step of, if measured calorie consumption exceeds reference calorie consumption or if measured body fat exceeds reference body fat as a result of the calculation, calling the user's attention thereto by providing an audible alarm, or emitting light through a light emitting unit.

### Advantageous Effects

The present invention can realize the following advantages through the above construction.

The present invention is constructed so that a display unit is provided in a controller attached to a shoe, and a user can monitor his or her calorie consumption anytime without having to carry a separate terminal, thus improving the convenience of use of the shoe.

The present invention is advantageous in that a controller attached to a shoe can be attached to or detached from the shoe, so that the controller can be prevented from being damaged when the shoe is cleaned, and can be easily repaired or replaced when the controller breaks down.

The present invention is advantageous in that, since a user can monitor his or her body fat in real time anytime, the user can check his or her fat state anytime.

The present invention is advantageous in that a user can check a pulse anytime, and can visually monitor his or her current heart condition, thus preventing the occurrence of accidental death caused by excessive exercise.

The present invention is advantageous in that a user personally inputs his or her height, weight, gender and shoe weight, so that the user can determine his or her optimal calorie consumption, thus maximizing the effect of exercise.

The present invention is advantageous in that insertable midsoles, having different weights and heights, are provided so as to vary the height and weight of a user, so that required calorie consumption can be arbitrarily adjusted, thus improving the effect of exercise.

The present invention is advantageous in that data about calorie consumptions, body fats and pulses of users is stored in a controller, and can be transmitted to a personal terminal or a mobile phone in a wired/wireless manner.

The present invention is advantageous in that data about measured calorie consumption, body fat and pulse is compared with reference values to provide an audible or visual alarm with respect to whether the quantity of motion per day has been achieved, whether excessive body fat is present, and whether an abnormality has occurred in the heart, thus calling the user's attention thereto.

The present invention is advantageous in that the power of a controller can be automatically cut off when a user does not exercise, thus preventing the consumption of battery power.

The present invention is advantageous in that a controller is installed in either one of the two shoes, thus improving the convenience of use of the controller, decreasing the production cost thereof, and further facilitating the maintenance thereof.

### BRIEF DESCRIPTION OF THE DRAWINGS

FIG. 1 is a perspective view of an artificial intelligence shoe according to an embodiment of the present invention;

FIG. 2 is a partially cutaway perspective view showing a state in which the pulse sensor and the walking sensor of the artificial intelligence shoe of FIG. 1 are connected to a controller;

FIG. 3 is a block diagram showing the controller of the artificial intelligence shoe according to an embodiment of the present invention;

FIG. 4 is a block diagram showing the walking sensing circuit unit of the controller of the artificial intelligence shoe according to an embodiment of the present invention;

FIG. 5 is a block diagram showing the body fat measurement circuit unit of the controller of the artificial intelligence shoe according to an embodiment of the present invention;

FIG. 6 is a block diagram showing the pulse sensing circuit unit of the controller of the artificial intelligence shoe according to an embodiment of the present invention;

FIG. 7 is an exploded perspective view showing a state in which the shoe body of the artificial intelligence shoe is separated from the controller according to an embodiment of the present invention;

FIG. 8 is an enlarged view showing the shoe body and the controller of FIG. 7;

FIG. 9 is a sectional view showing a state in which the shoe body of the artificial intelligence shoe is combined with the controller according to an embodiment of the present invention;

FIG. 10 is a view showing a state in which the controller of the artificial intelligence shoe is attached to the insole of the shoe body according to an embodiment of the present invention;

FIG. 11 is a view showing a state in which the controller of the artificial intelligence shoe is attached to the midsole of the shoe body according to an embodiment of the present invention;

FIG. 12 is a view showing a state in which the controller of the artificial intelligence shoe is attached to the bottom of the outsole of the shoe body according to an embodiment of the present invention;

FIG. 13 is a view showing a state in which the controller of the artificial intelligence shoe is attached to a region covering the midsole and upper of the shoe body according to an embodiment of the present invention;

FIG. 14 is a view showing a state in which the controller of the artificial intelligence shoe is attached to a region covering the upper, the midsole and the outsole of the shoe body according to an embodiment of the present invention;

FIG. 15 is a perspective view showing a midsole and an insole, for setting weight, to be inserted into the artificial intelligence shoe according to an embodiment of the present invention;

FIG. 16 is a perspective view showing a midsole and an insole, for setting height, to be inserted into the artificial intelligence shoe according to an embodiment of the present invention;

FIG. 17 is a top perspective view showing a midsole to be inserted into the artificial intelligence shoe and adapted to improve air permeability according to an embodiment of the present invention;

FIG. 18 is a bottom perspective view showing a midsole to be inserted into the artificial intelligence shoe and adapted to improve air permeability according to an embodiment of the present invention;

FIG. 19 is a sectional view showing the midsole of FIGS. 17 and 18 taken along a longitudinal direction; and

FIG. 20 is a top perspective view showing an insole to be inserted into the artificial intelligence shoe and adapted to improve air permeability and antibiotic property according to an embodiment of the present invention.

### BEST MODE FOR CARRYING OUT THE INVENTION

The present applicant will describe the above-described embodiments in detail with reference to the attached drawings.

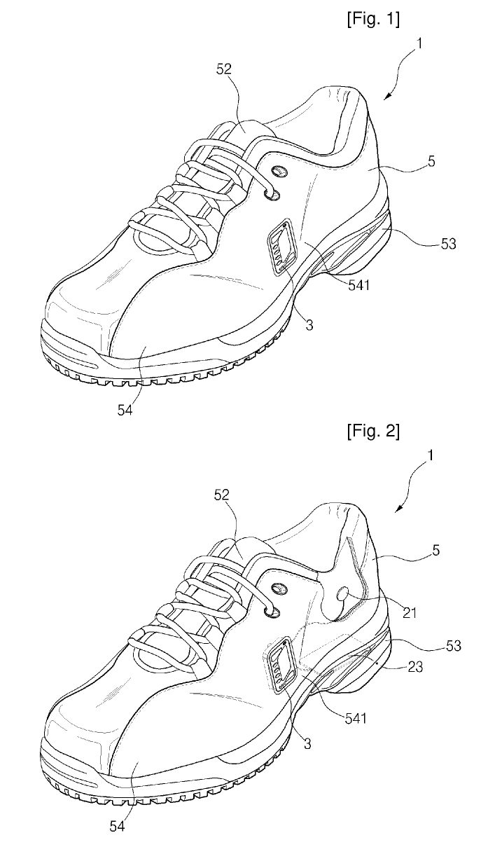

FIG. 1 is a perspective view showing an artificial intelligence shoe according to an embodiment of the present invention, and FIG. 2 is a partially cutaway perspective view showing a state in which the pulse sensor and the walking sensor of the artificial intelligence shoe of FIG. 1 are connected to a controller.

Referring to FIGS. 1 and 2, an artificial intelligence shoe 1 according to the present invention includes a walking sensor 23, a pulse sensor 21, a controller 3, and a shoe body 5.

As the walking sensor 23, any sensor, which can be embedded in the shoe and is capable of sensing the instant that the shoe lands on the ground and the instant that the shoe leaves the ground when a user walks, can be adopted. The walking sensor is provided in either of the two shoes, and is operated to generate an ON signal when the shoe including the walking sensor lands on the ground, generate an OFF signal when the shoe leaves the ground, and generate an ON signal again when the shoe lands on the ground again. Accordingly, as described later, the temporal difference between the generation of an initial ON signal and the generation of a subsequent ON signal (or the temporal difference between the generation of an initial OFF signal and the generation of a subsequent OFF signal) is calculated, thus a speed per step is calculated. Actual calorie consumption is calculated using the speed per step. As an example, a metal contact switch can be used. The metal contact switch embedded in the shoe is operated so that, if the shoe comes into contact with the ground and is pressurized by the ground, current flows therethrough to generate an ON signal, whereas, if the shoe leaves the ground, current does not flow therethrough, thus generating an OFF signal. As the metal contact switch, a two-wire or four-wire structure can be used.

As described above, since the walking sensor 23 uses a load to sense the contact of the shoe with the ground, the walking sensor 23 must be installed at a location to which a load can be applied. For example, the walking sensor 23 can be installed on a predetermined location on the outsole, midsole, or insole of the shoe. Further, the walking sensor 23 is preferably installed on a midsole or an insole, which is designed to be detachable, for convenience of repair or replacement.

Further, as shown in FIG. 2, the walking sensor 23 is connected in a wired manner to the controller, which will be described later. If necessary, the walking sensor 23 can communicate with the controller in a wireless communication manner. As typical well-known technology, local area wireless communication, such as Zigbee or Bluetooth, can be used.

The pulse sensor 21 is a sensor which is installed in the inside of the shoe, corresponding to the location of an artery of the foot, for example, the top side of the foot, or the Achilles' tendon, and which is adapted to sense the pulse of the artery of the foot of the user. For the pulse sensor, a piezoelectric sensor for sensing the fine pulse of the artery and outputting the sensed pulse as an Alternating Current (AC) voltage, or an optical sensor for sensing the pulse using the amount of transmitted light can be used as an example. However, it is apparent that various well-known sensors can be used. Further, if the pulse sensor 21 is implemented using a piezoelectric sensor or an optical sensor, and a user puts on socks before putting on the shoes and exercising, the user measures his or her pulse by putting on the shoes for a predetermined period after taking off the socks when feeling an abnormality in his or her body, when resting from exercise, or before and after exercise. Further, the user can measure his or her pulse using the pulse sensor 21 by wearing special socks that enable the top side of the foot or the region near the Achilles' tendon to be exposed to the pulse sensor 21. Further, if the user wears special socks when desiring to measure a pulse, the pulse can be measured anytime while wearing the socks. When wearing typical socks, the user can measure his or her pulse anytime by putting on the shoes after taking off the socks. Anyway, if the pulse period is measured using the pulse sensor, and the inverse number of the pulse period is taken, a pulse rate can be obtained, using the following equation.

$$pulse rate = \frac{60}{pulse period}$$

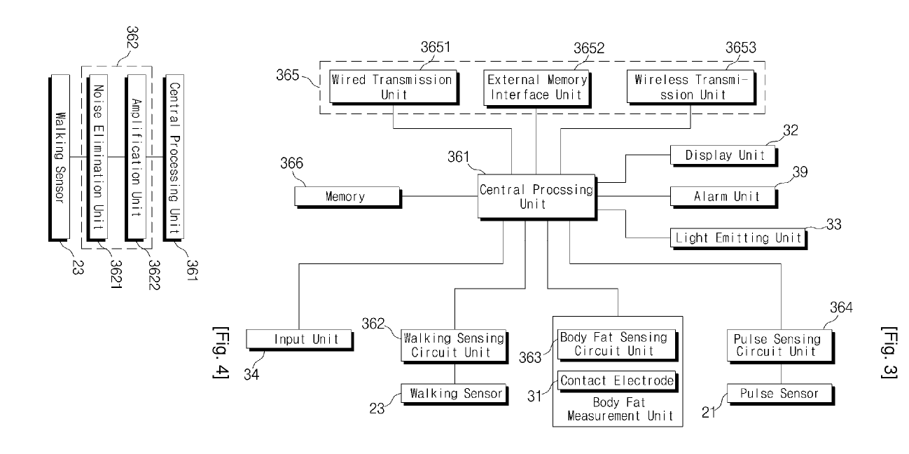

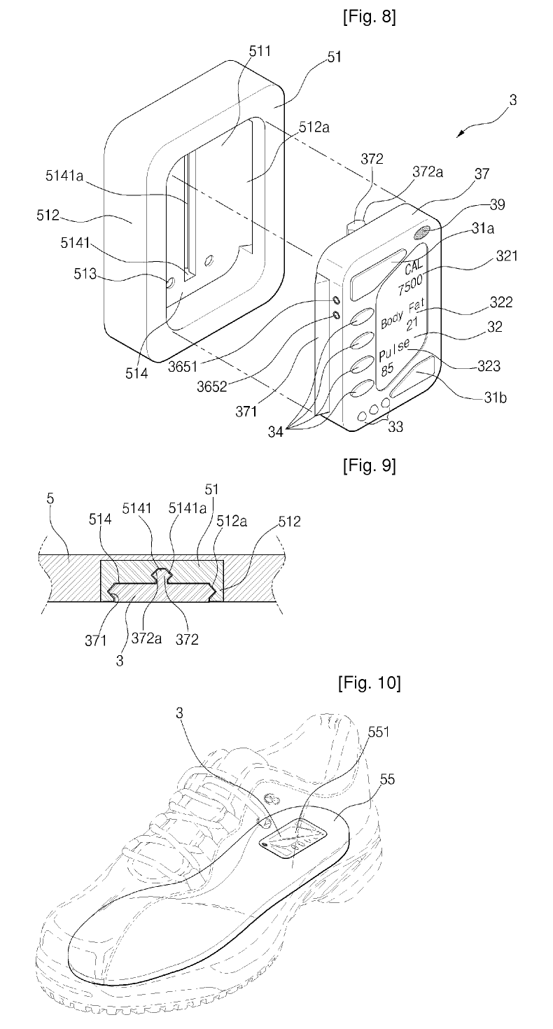

Referring to both FIG. 3, showing the block diagram of the controller of the artificial intelligence shoe according to an embodiment of the present invention, and FIG. 8, showing an enlarged view of the shoe body and the controller, the controller 3 has a shape in which various types of Printed Circuit Boards (PCBs) are installed in a box-shaped controller housing 37, and in which a transparent window is attached to the open front portion of the controller housing. The controller includes an input unit 34, a central processing unit 361, a display unit 32, an alarm unit 39, a light emitting unit 33, a transmission unit 365, and memory 366.

The input unit 34 is a circuit unit, which includes input buttons for inputting the user's weight, gender, age, height and shoe weight, and which processes information input using these buttons. Further, the input unit may have a mode selection function for selecting information to be displayed on a display unit, which will be described later, in addition to the function of inputting various types of information. Furthermore, the input unit can also be used to turn on or off the power of the controller, to store measured information, or to transmit the measured information to external devices.

The central processing unit 361 functions to control the overall operation of the controller, such as by calculating calorie consumption, body fat, pulse, etc. using various types of information input from the input unit, information input from the walking sensor 23, a contact electrode 31, and the pulse sensor 21, and information stored in the memory 366, by comparing calculated result values with various reference values to determine whether the calculated result values have reached the reference values, and by storing the calculated data in the memory in response to the user's request.

The display unit 32 includes a calorie consumption display unit 321 for displaying calorie consumption calculated by the central processing unit in real time, a body fat display unit 322 for displaying measured body fat, as will be described later, and a pulse display unit 323 for displaying a measured pulse in real time. According to another embodiment of the present invention, the display unit 32 further includes a backlight structure that functions as a safety lamp to visually indicate various types of displayed information during night exercise, and that notifies other persons that the user is exercising. The backlight structure is implemented using well-known technology, which has been generally adopted in typical liquid crystal display structures.

The light emitting unit 33 functions to indicate, using various colors, appropriate exercise levels obtained when the central processing unit 361 compares actual calorie consumption with reference calorie consumption (the reference calorie consumption corresponding to input physical information, and the calorie consumption being detected in a reference calorie table, which will be described later), and determines whether the actual calorie consumption has reached the reference calorie consumption. For example, if the reference calorie consumption has not been achieved, a red lamp may be turned on, whereas, if the reference calorie consumption has been achieved, a green lamp may be turned on. For the light emitting unit, various light emitting elements, such as a Light Emitting Diode (LED), or an electroluminescent (EL) backlight can be used. Of course, if necessary, the appropriate level of measured body fat, abnormalities in a pulse, etc. can also be displayed through the light emitting unit.

Unlike the light emitting unit for indicating appropriate exercise levels using light, the alarm unit 39 functions to audibly indicate appropriate exercise levels. For example, when reference calorie consumption has not been achieved, when excessive body fat is present, or when a pulse is abnormal, the alarm unit 39 can generate alarm sounds using various methods.

The transmission unit 365 functions to transmit various types of information stored in the controller to external devices (for example, a portable terminal, a portable PC, or a personal computer), and may include a wired transmission unit 3651 connected to various types of external devices in a wired manner, an external memory interface unit 3652 adapted to cause external memory to be directly inserted thereinto, and a wireless transmission unit 3653 provided with a local area communication module, such as modules for Zigbee, Bluetooth or Ultra Wide Band (UWB) communication, so as to transmit data to external devices or receive data from external devices in a wireless manner.

The memory 366 stores information input by the user, for example, physical information such as the user's height, weight, gender and age, the user's step coefficient, a table of calorie consumption per minute per kg according to speed per step (hereinafter referred to as a ‘reference calorie table’), a reference body fat table, a reference pulse table, actually measured calorie consumption (hereinafter referred to as ‘measured calorie consumption’), the measured amount of fat in the body (hereinafter referred to as a ‘measured body fat’), a measured pulse value (hereinafter referred to as a ‘measured pulse value’), etc. In this case, the reference calorie table is configured in such a way that a suitable amount of calories to be consumed per day according to the age, gender, height and weight of each user are represented using calorie coefficients and are arranged in the form of a table. The reference body fat table or the reference pulse table is configured in such a manner.

According to a further embodiment of the present invention, referring to FIG. 4, the controller 3 may further include a walking sensing circuit unit 362 for processing a signal input from the walking sensor 23. The walking sensing circuit unit 362 includes a noise elimination unit 3621 for eliminating noise from the signal input from the walking sensor 23 and an amplification unit 3622 for amplifying a signal output from the noise elimination unit and transmitting the amplified signal to the central processing unit 361.

According to yet another embodiment of the present invention, referring to FIGS. 3 and 8, the controller 3 may further include a contact electrode 31 required to measure body fat. For the contact electrode 31, electrodes 31a and 31b are installed at predetermined locations on the controller and are made of a conductive material capable of supporting conduction with respect to a human body. The reason for this is to cause the electrodes to come into contact with both hands of the user. In this case, after separating the controller 3 from the shoe, the user stands up with both legs together while stretching his or her back, stretches both hands forward, and puts the hands on the contact electrodes 31a and 31b of the controller 3, thus precisely measuring body fat. The amount of fat in the body is theoretically based on bioelectrical impedance analysis. If a constant AC current of 500 μA to 1 mA having a certain frequency (for example, 50 KHz) is caused to flow through the human body under the control of the central processing unit 361 while the user puts one finger of the right hand and one finger of the left hand on the contact electrodes 31a and 31b, respectively, the corresponding constant current passes through the human body. If the amount of fat in the human body is large, the electrical resistance of the body increases. In detail, fat and body fat are defined by the following well-known equations, where K is a constant.

$$fat = K \frac{resistance}{{height}^{2}}$$

$$body fat = 100 \frac{fat}{weight}$$

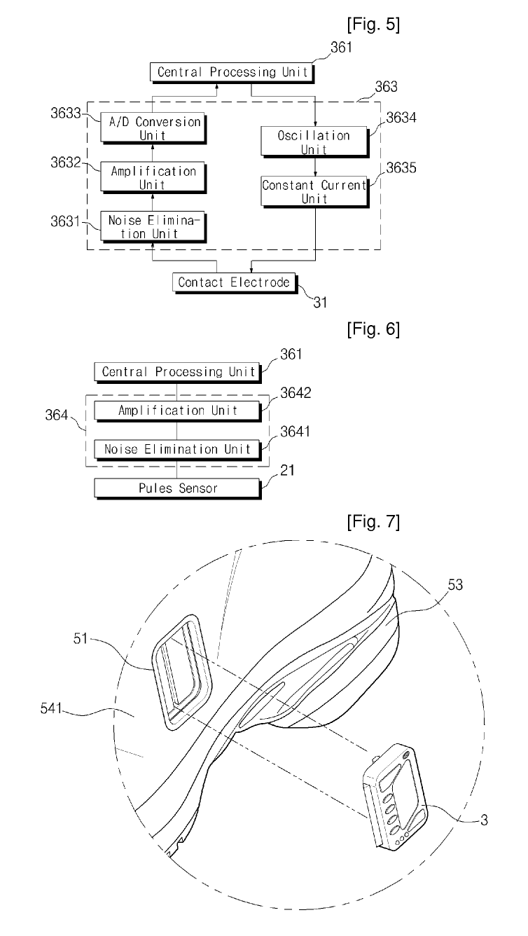

According to still another embodiment of the present invention, referring to FIG. 5, the controller 3 may further include a body fat sensing circuit unit 363. The body fat sensing circuit unit 363 includes an oscillation unit 3634 for generating a predetermined oscillation signal under the control of the central processing unit 361, a constant current unit 3635 for receiving the oscillation signal from the oscillation unit and outputting constant current to the contact electrode 31a on one side, a noise elimination unit 3631 for eliminating noise from the current flowing into the body fat sensing circuit unit 363 through the contact electrode 31b on the other side, an amplification unit 3632 for amplifying the current output from the noise elimination unit, and an Analog/Digital (A/D) conversion unit 3633 for converting the current output from the amplification unit into DC current, and transmitting the DC current to the central processing unit. Therefore, the central processing unit 361 calculates resistance using DC voltage, which is generated by the body fat sensing circuit unit and flows into the body fat sensing circuit unit through the human body, and calculates fat and body fat using the above-described equations.

According to still another embodiment of the present invention, as shown in FIG. 6, the controller 3 may further include a pulse sensing circuit unit 364. The pulse sensing circuit unit 364 includes a noise elimination unit 3641 for receiving the output signal of the pulse sensor 21 and eliminating noise from the output signal, and an amplification unit 3642 for amplifying the output signal of the noise elimination unit 3641 and transmitting the amplified signal to the central processing unit 361.

According to still another embodiment of the present invention, although not shown in the drawings, the controller 3 may further include a power cutoff unit. The power cutoff unit can be implemented using various schemes. For example, the power cutoff unit may be a circuit for causing the central processing unit to automatically cut off power when no signal has been generated by the walking sensor or the pulse sensor for a predetermined period of time.

Various constructions of the controller, as described above, are implemented on one or more PCBs. As shown in FIGS. 8 and 9, the PCBs are installed in a controller housing 37, the rear surface of which is closed, and the front surface of which is open and can be covered by a separate transparent window (at least a portion of which is transparent) to be waterproof and dustproof. Of course, the controller housing is constructed so that the various buttons 34, the contact electrodes 31a and 31b, and the light emitting unit 33 can be exposed through the transparent window.

The controller housing 37 has first fitting protrusions 371 on the sides thereof. The first fitting protrusions 371 protrude outwards from the sides of the controller housing 37, and are fitted into first fitting recesses 512a of a controller case, which will be described later, thus enabling the controller to remain securely engaged even during exercise. The first fitting protrusions 371 can be wholly or partially formed along the circumferences of the sides of the controller housing. According to still another embodiment of the present invention, the controller housing 37 has a second fitting protrusion 372 protruding from the rear surface thereof. The second fitting protrusion 372 is fitted into the second fitting recess 5141 of the controller case, which will be described later, and thus functions to more firmly support the controller. The second fitting protrusion 372 may further include auxiliary protrusions 372a on one or more of both sides of the second fitting protrusion 372. Since the auxiliary protrusions 372a protrude a predetermined length from the side walls of the second fitting protrusion, the auxiliary protrusions 372a are fitted into auxiliary recesses 5141a, thus more firmly supporting the controller. Further, since the controller must not only be firmly attached to the shoe, but also be separated from the shoe when the user is not exercising or wants to clean the shoe, both excellent detachability and secure engagement must be satisfied. The first fitting protrusions, the second fitting protrusion, and the auxiliary protrusions preferably have a structure capable of satisfying the above conditions. As an example, as shown in FIGS. 8 and 9, the first fitting protrusions and the auxiliary protrusions preferably have a triangular section.

Further, although not shown in the drawings, the controller housing 37 has terminals on the rear surface thereof to receive the output signals of the walking sensor 23 and the pulse sensor 21, such terminals being connected to the opposite terminals 513 of the controller case, shown in FIG. 8.

The shoe body 5 includes an upper 54 having the shape of the foot of a human body, an outsole 53 placed below a midsole for fixedly supporting the outer circumference of the upper, or adapted to directly fixedly supporting the outer circumference of the upper, the midsole 56 placed on the outsole or detachably placed on the inside of the upper, and an insole 55 seated on the midsole. The controller is attached to a predetermined location on any of the upper, the insole, the midsole, and the outsole.

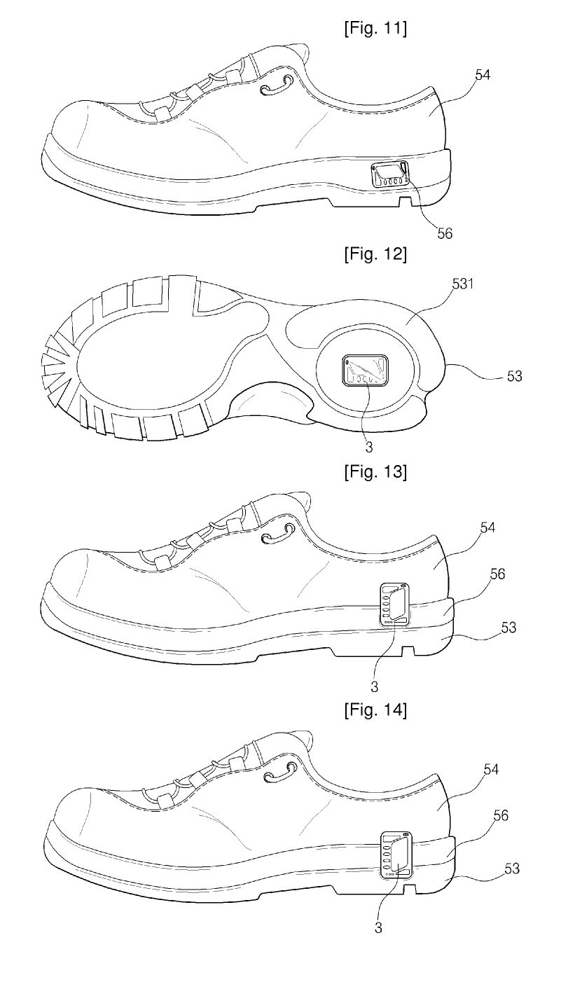

The midsole 56 may be a fixed midsole which is placed on the outsole 53 so as to fixedly support the outer circumference of the upper (refer to FIGS. 11, 13, and 14), or may be a detachable midsole which is detachably installed inside the shoe (refer to FIGS. 15, 16, 17, 18 and 19). In the case of the detachable midsole shown in FIG. 15, the midsole can be provided as a set of various types of midsoles 56 and insoles 55 having various weights, together with the insole 55. The user can select midsoles and insoles having various weights according to the circumstances, in order to control calorie consumption. For example, in the case where the user takes exercise after inserting a heavy midsole and insole into the shoe, predetermined calorie consumption can be achieved in a relatively short period, compared to other cases. However, in the case where the user uses a light midsole and insole, a lot of time is required to achieve the same calorie consumption. Accordingly, the user selectively uses midsoles and insoles having various weights according to his or her preference, thus suitably controlling his or her quantity of motion. This will be described later.

In the case of the detachable midsole shown in FIG. 16, various midsoles with heels having different heights h are provided. The reason for this is that recommended calorie consumption varies with the height of the user, so that the user freely selects various midsoles having different heel heights h, thus arbitrarily changing his or her height, and consequently suitably controlling his or her quantity of motion.

Referring to FIGS. 7 to 9, the shoe body 5 may further include a controller case 51. The controller case 51 is a box-shaped member, which includes an opening 511 having a contour corresponding to the contour of the controller so that the controller can be inserted and fitted into the opening. The opening is defined by side walls 512 and a bottom surface 514 surrounding the opening. The side walls 512 include first fitting recesses 512a having shapes corresponding to the shapes of the first fitting protrusions 371 of the controller. The first fitting recesses 512a can be wholly or partially formed in the side walls. According to still another embodiment of the present invention, the bottom surface 514 includes the second fitting recess 5141 having a shape corresponding to the shape of the second fitting protrusion 372. Furthermore, the second fitting recess 5141 may further have auxiliary recesses 5141a having a shape corresponding to the shape of the auxiliary protrusions 372a to cause the auxiliary protrusions to be fitted and inserted into the auxiliary recesses. Further, the controller case 51 has opposite terminals 513 on the bottom surface 514 or another surface. Since the opposite terminals 513 are connected to the walking sensor and/or the pulse sensor in a wired manner, they interface with the terminals of the controller, thus transmitting data measured by those sensors to the controller.

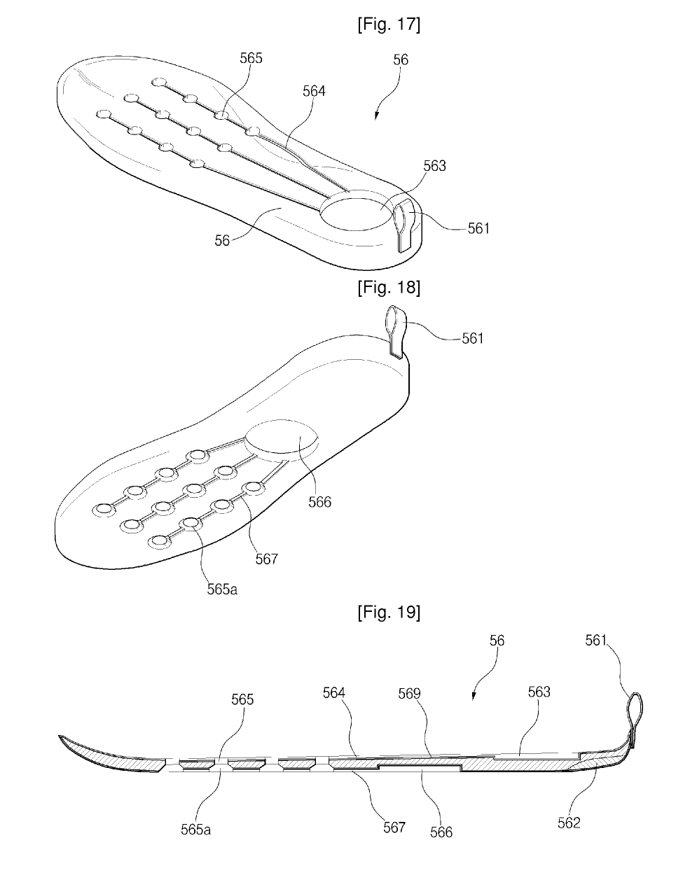

According to still another embodiment of the present invention, the midsole of FIGS. 17 to 19 can be embodied so as to increase the usefulness of the artificial intelligence shoe 1. FIG. 17 is a top perspective view showing a midsole to be inserted into the artificial intelligence shoe and adapted to improve air permeability according to an embodiment of the present invention, FIG. 18 is a bottom perspective view showing a midsole to be inserted into the artificial intelligence shoe and adapted to improve air permeability according to an embodiment of the present invention, and FIG. 19 is a sectional view showing the midsole of FIGS. 17 and 18 taken along a longitudinal direction. Referring to FIG. 17, the midsole 56 includes a top air-containing depression 563 formed on the top of the heel thereof, a plurality of through holes 565 perforated to be spaced apart from the air-containing depression by a certain distance, top flow paths 564 for connecting the through holes to the top air-containing depression, a bottom air-containing depression 566 formed on the bottom thereof, and bottom flow paths 567 for connecting the bottom air-containing depression to the through holes.

The top air-containing depression 563 contains air and is operated such that, if the insole placed on the top air-containing depression is pressurized by a person and the ground when the user lands on the ground, air flows along the top flow paths 564 toward the bottom of the midsole through the through holes 565, or is forced to flow into the shoe, thus circulating air and heat, contained in the shoe, and consequently diffusing bad smells and sweat to the outside of the shoe. Similarly, the bottom air-containing depression 566 also contains air, and is operated such that when the user lands on the ground, air is forced to flow into the through holes 565 through the bottom flow paths 567 using the same method, thus circulating air and heat, contained in the shoe, and consequently diffusing bad smells and sweat to the outside of the shoe. According to still another embodiment of the present invention, each of the through holes formed on the bottom of the midsole includes an inlet 565a having a frustoconical shape, thus the air confined in the space between the midsole and the outsole can be more forcefully pumped to the outside.

According to still another embodiment of the present invention, as shown in FIGS. 17 to 19, when the midsole is implemented as a detachable type, the midsole may further include a loop part 561 formed on a portion of the heel of the midsole to enable a finger to be inserted thereinto for convenient attachment or detachment. Further, according to still another embodiment of the present invention, as shown in FIG. 19, the midsole may preferably further include an impact absorption part 562 formed on the bottom of the heel thereof, so that the impact of landing can be absorbed, thus improving excellent wear properties and reducing fatigue during exercise.

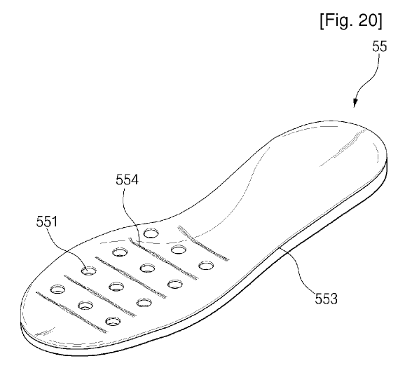

According to still another embodiment of the present invention, antibacterial layers 569 and 553 can be formed on the midsole and the insole, respectively, as shown in FIGS. 19 and 20.

Referring to FIG. 20, in the case of the insole 55, the antibacterial layer 553 can be formed by individually applying silver nano liquid, ceramic negative ions, and vitamin C, or applying a liquid mixture thereof. Further, silver yarn fabric 554 is partially adhered to the insole, separately from or together with the antibacterial layer, thus antibacterial processing can be performed. Further, in order to further improve air permeability, a plurality of through holes 551 can be formed in a forefoot portion.

Referring to FIG. 19, in the case of the midsole 56, the antibacterial layer 569 can be formed by individually applying silver nano liquid, ceramic negative ions, and vitamin C, or applying a liquid mixture thereof.

According to still another embodiment of the present invention, although not shown in the drawings, the shoe may further include a weight sensor for automatically sensing the user's weight and/or the weight of the shoe. For the weight sensor, various well-known sensors, for example, a load cell, can be used. In this way, if the weight sensor is used, there is no need to personally input weight when the user's weight changes, or whenever the weight of the shoe is changed by differently setting the weights of the midsole and the insole, as described above, thus improving the convenience of use of the shoe.

Hereinafter, the assembly relationship of the present invention is described.

Referring to FIGS. 1, 2, and 7 to 9, the controller is installed on a center location 541 on the quarter of the upper of the shoe (the installation location can be varied without being limited to the center location on the quarter, and will be described later) that does not interfere with walking motion. The controller is firmly fitted into the controller case 51. Then, the walking sensor 23 is embedded in a portion of the heel of the outsole of the shoe, and is connected to the opposite terminals 513 of the controller case 51 in a wired manner. In this case, a wire is preferably embedded in the inner side of the upper of the shoe in order to prevent the wire from being seen from the outside, and is preferably implemented using a waterproof wire so as to prevent water from flowing into the wire when the shoe is cleaned later. Further, when it is desired to install the pulse sensor 21, it is preferably installed on the location of the shoe which corresponds to the location of an artery of the foot, for example, the top side of the foot, that is, the tongue 52 of the shoe, or the location of the shoe which corresponds to the Achilles' tendon of the foot, as shown in FIG. 2, and is preferably connected to the opposite terminals of the controller case in a wired manner, similar to the walking sensor. In this case, when a wireless transmission method, rather than the wired method, is used, a separate wiring operation can be omitted, but, in this case, the walking sensor, the pulse sensor and the controller must be provided with wireless transmission/reception modules.

After the operation of installing the walking sensor, the pulse sensor, and the controller case has been completed in this way, the controller is inserted into the controller case. At this time, while the controller is inserted into the opening 511 of the controller case 51, the first fitting protrusions 371 of the controller are fitted into the first fitting recesses 512a of the controller case 51, and the second fitting protrusion 372 of the controller is fitted into the second fitting recess 5141 of the controller case if the second fitting protrusion exists. Simultaneously, the terminals of the controller are precisely fitted into the opposite terminals 513 of the controller case. Further, if the second fitting protrusion of the controller has the auxiliary protrusions 372a, the auxiliary protrusions are fitted into the auxiliary recesses 5141a of the controller case. Through the above process, the controller is firmly detachably engaged with the controller case, thus securely maintaining an excellent engaged state even during exercise.

Meanwhile, the controller can be installed in various locations of the shoe. An important factor is that the controller must be installed in a location that does not interfere with walking motion during the user's walking motion. The present applicant shows examples thereof in FIGS. 10 to 14.

FIG. 10 is a view showing a state in which the controller of the artificial intelligence shoe is attached to the insole of the shoe body according to an embodiment of the present invention. As shown in the drawing, when the controller 3 is installed on the insole 55, the entire surface of the controller is covered with a cushion member 551 made of a transparent material, and the bottom of the foot is prevented from directly touching the controller in order to prevent the controller from being damaged by the pressure between the bottom of the foot and the ground during landing, or prevent the user from feeling something touching the foot.

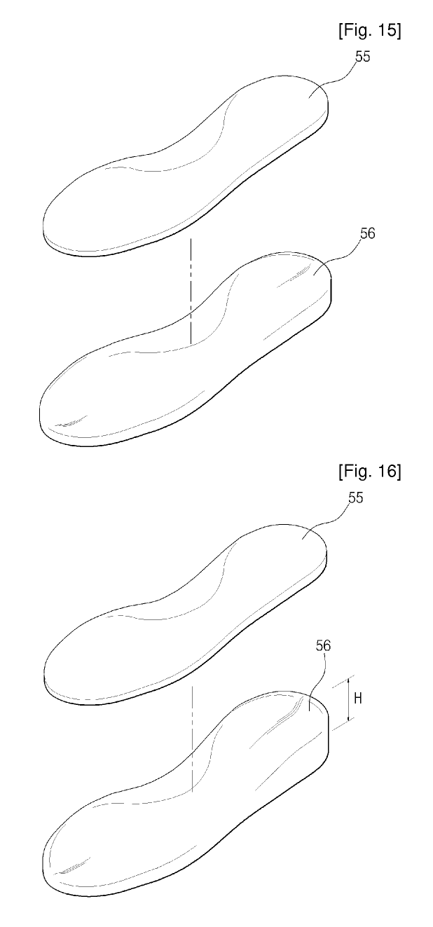

As another example, the controller is installed on the midsole 56 of the shoe, as shown in FIG. 11, or is installed on the outsole of the shoe, with the front surface of the controller facing the bottom of the outsole, as shown in FIG. 12, or is installed in a region covering the upper 54 and the midsole 56 of the shoe, as shown in FIG. 13, or is installed in a region covering the upper 54, the midsole 56, and the outsole 53 of the shoe, as shown in FIG. 14.

Hereinafter, the use of the artificial intelligence shoe according to the present invention is described.

A user first turns on the controller by pressing the power button, among the input buttons of the input unit 34, and supplies power to the walking sensor, the pulse sensor, etc. Next, the user inputs his weight, age, gender, height, and shoe weight using the input buttons of the input unit 34. The reason for inputting the weight is to detect the most highly recommended calorie consumption for the user because an overweight person has a higher recommended calorie consumption than a person having a suitable weight. The reason for inputting age is to reflect the fact that a younger person requires higher calorie consumption than an older person. The reason for inputting gender is to reflect the fact that a man requires higher calorie consumption than a woman. The reason for inputting height is to reflect the fact that a taller person requires higher calorie consumption than a shorter person. The reason for inputting the weight of the shoe is to precisely determine the appropriate exercise level in consideration of different calorie consumptions depending on the weights of shoes because calorie consumptions differ from each other depending on the weights of shoes. In the above embodiments, the reason for providing insoles and midsoles having various weights and heights is described herein.

Next, when the user starts to walk or run, the walking sensor installed in the bottom of the shoe repeatedly generates ON/OFF signals. The central processing unit receives the ON/OFF signals, calculates calorie consumption according to the following theories and equations, and displays the calculated calorie consumption on the display unit 32.

Calorie consumption occurring when walking or running is influenced by the speed thereof in the case of the same person, and is influenced by the weights, shoe weights and heights of respective persons in the case of the same speed. The present applicant defines the following step coefficient P on the basis of the above fact, thus enabling each person's step to be calculated as long as the height of the person is known. In this case, step coefficients for respective heights, obtained by actually performing walking or running experiments on persons having different heights, are arranged in the form of a table, and are stored in the memory.

$$step coefficient ( P ) = \frac{step}{height}$$

Therefore, if the user inputs his or her height, the central processing unit calculates the user's step with reference to the step coefficient table.

Next, if the user starts to walk, the walking sensor generates an ON signal when landing, and an OFF signal when leaving the ground, thus the central processing unit calculates the temporal difference T between the landing time point and a subsequent landing time point, and consequently calculates speed per step S on the basis of the following equation.

$$speed ( S ) = step \times step number per hour = step \times \frac{360000}{T} ( cm \text{/} hr )$$

Next, the central processing unit calculates a calorie coefficient per minute per kg according to speed per step using the following interpolation equation, with reference to the reference calorie table stored in the memory 366. First, the speed S1 just higher than the calculated speed per step S is obtained from the reference calorie table, and a calorie coefficient K1 corresponding to the speed S1 is found. Next, the speed S2 just lower than the calculated speed S is obtained, and a calorie coefficient K2 corresponding to the speed S2 is found. Thereafter, the calorie coefficient per minute K is calculated using the following interpolation equation.

$$K = \frac{K 2 - K 1}{S 2 - S 1} ( S - S 1 ) + K 1$$

If the above process is performed, calorie consumption per minute q is readily calculated using the following equation,

q=W×K(cal)

where W is the sum of the weight of the user and the weight of the shoe.

Finally, calorie consumption Q, obtained when the user walks for one hour, is defined by the following equation.

Q=60WK(cal)

Further, the number of steps per hour is

$$N = \frac{360000}{T} .$$

Therefore, calorie consumption per step Q′ is obtained using the following equation.

$${Q}^{′} = \frac{Q}{N} = \frac{KWT}{60000} ( cal )$$

Through the above process, the central processing unit calculates measured calorie consumption and displays the measured calorie consumption in real time on the display unit 32. If the measured calorie consumption has not reached a reference calorie consumption, the central processing unit provides an audible alarm through the alarm unit 39 or turns on a red lamp through the light emitting diode 33. In contrast, if the measured calorie consumption has reached the reference calorie consumption, the central processing unit turns on a green lamp through the light emitting unit, and stores the measured calorie consumption in the memory 366.

Meanwhile, a process of measuring body fat is described. As described above, body fat is measured on the basis of the fact that electric current does not flow through fat in the body and the fat functions as resistance. When the body fat is intended to be precisely measured, the controller 3 is detached from the shoe, and thereafter the user stands up with both legs together while stretching his or her back, stretches both hands forward, and puts the hands on the contact electrodes 31a and 31b of the controller 3. If a constant AC current of 500 μA to 1 mA having a predetermined frequency (for example, about 50 KHz) is caused to flow through the human body under the control of the central processing unit 361, the central processing unit 361 calculates a measured body fat using the measured resistance value of the body and the input height and weight using the above equations. Further, the central processing unit finds a reference body fat in a reference body fat table stored in the memory in consideration of the user's height and weight, determines whether the user has low body fat or excessive body fat by comparing the reference body fat with the measured body fat, and displays the measured body fat on the display unit 32. If the user is found to have excessive body fat, the central processing unit provides an audible alarm through the alarm unit 39, or turns on a red lamp through the light emitting unit 33, whereas if the user is found to have suitable body fat, the central processing unit turns on a green lamp through the light emitting unit and stores the measured body fat in the memory 366.

Subsequently, the process for measuring a pulse is described. If the user wears shoes, the pulse sensor placed near the artery of the foot senses a pulse, generates a signal, and transmits the signal to the central processing unit. The central processing unit receives the signal, checks the period of the pulse, and calculates a pulse rate using the following equation.

$$pulse rate = \frac{60}{pulse period} ( beats \text{/} minute )$$

In this way, if the central processing unit calculates the pulse rate, it transmits the pulse rate to the display unit 32 and displays the pulse rate on the display unit. If the pulse rate increases excessively, the central processing unit determines that an abnormality occurs in the heart, provides an audible alarm through the alarm unit 39, or turns on a red lamp through the light emitting unit 33. Therefore, the user can check in real time whether an abnormality is occurring in the heart through the audible or visual checking procedure.

Meanwhile, the user arbitrarily adjusts the weight of the shoe and his or her height by differently setting the weights or heights of the midsole and the insole, thus arbitrarily controlling calorie consumption or body fat as required.

As described above, the user can monitor his or her calorie consumption, body fat and pulse in real time, thus checking his or her appropriate exercise level. Further, since the controller is provided with the transmission unit 365, and stores all measured information in memory, the user can download the information stored in the controller to an external device (a portable computer, a mobile phone, or a personal computer) in a wired or wireless manner, can analyze the downloaded information, or can transmit such information to a medical institution over the Internet and receive remote medical treatment, such as video medical treatment, from a medical specialist.

Further, after the user terminates exercise, the power cutoff unit automatically determines whether exercise is being performed, and automatically cuts off power, thus preventing the consumption of battery power. Further, when cleaning is required, the controller is separated from the shoe, and only the shoe body is cleaned, thus preventing the controller from being damaged.

1. Artificial intelligence shoes, comprising:
a walking sensor embedded in one of the shoes to sense whether a user is walking; and
a controller for receiving a signal from the walking sensor, and calculating calorie consumption,
wherein the walking sensor periodically generates ON/OFF signals when the shoe lands on a ground and when the shoe leaves the ground, depending on walking of the user, and
wherein the controller is detachably attached to the shoe, and comprises a body fat measurement unit provided with conductive contact electrodes for causing current to flow into a body of the user in order to measure the user's body fat, and a display unit for displaying calorie consumption calculated based on a walking speed, derived from a temporal difference, which is calculated for the ON/OFF signals received from the walking sensor, and a measured body fat calculated by the body fat measurement unit.

2. The artificial intelligence shoes according to claim 1, further comprising a pulse sensor for measuring a pulse of the user, wherein the controller receives a signal measured by the pulse sensor and additionally calculates the user's pulse, and the display unit additionally displays the calculated pulse.

3. The artificial intelligence shoes according to claim 2, wherein the controller further comprises an input unit for inputting physical information about the user, a central processing unit for calculating and processing various types of information, and memory for storing various types of information.

4. The artificial intelligence shoes according to claim 3, wherein the controller further comprises a light emitting unit for variously emitting light with respect to a case where the user has taken insufficient exercise, or a case where an abnormality occurs in a heart of the user.

5. The artificial intelligence shoes according to claim 3, wherein the controller further comprises an alarm unit for providing an audible alarm with respect to a case where the user has taken insufficient exercise, or a case where an abnormality occurs in a heart of the user.

6. The artificial intelligence shoes according to claim 3, wherein the controller further comprises a transmission unit for transmitting various types of information to an external device.

7. The artificial intelligence shoes according to claim 6, wherein the transmission unit comprises at least one of a wired transmission unit, a wireless transmission unit, and an external memory interface unit.

8. The artificial intelligence shoes according to claim 3, wherein the input unit is implemented to enable input of at least one of the user's age, gender, height and weight.

9. The artificial intelligence shoes according to claim 3, wherein the controller further comprises a walking sensing circuit unit for eliminating noise from a signal received from the walking sensor and amplifying a noise-eliminated signal.

10. The artificial intelligence shoes according to claim 3, wherein the controller further comprises a pulse sensing circuit unit for eliminating noise from a signal received from the pulse sensor and amplifying a noise-eliminated signal.

11. The artificial intelligence shoes according to claim 2, wherein the body fat measurement unit further comprises a body fat sensing circuit unit for generating a predetermined oscillation signal, transmitting the oscillation signal to a conductive contact electrode on a first side, and transmitting the signal, which flows from the conductive contact electrode on the first side into a conductive contact electrode on a second side through a human body, to the central processing unit.

12. The artificial intelligence shoes according to claim 2, wherein the walking sensor is embedded in either of two shoes.

13. The artificial intelligence shoes according to claim 12, wherein the walking sensor is a metal contact switch.

14. The artificial intelligence shoes according to claim 2, wherein the pulse sensor is inserted into at least one of a portion of the shoe corresponding to the Achilles' tendon of the user, and a portion of the shoe corresponding to a top side of a foot of the user.

15. The artificial intelligence shoes according to claim 14, wherein the pulse sensor is any one of a piezoelectric sensor for converting a minute pulse of an artery into a fine voltage, and an optical sensor for radiating light onto blood in an artery and thus sensing a pulse.

16. The artificial intelligence shoes according to claim 2, wherein the controller is detachably attached to a controller case embedded in a predetermined location in the shoe.

17. The artificial intelligence shoes according to claim 16, wherein the controller case is a box-shaped member having a first open side and a second closed side and having a first fitting recess on a side thereof, and the controller comprises a first fitting protrusion on an outer circumference thereof, so that the first fitting protrusion is fitted into the first fitting recess, thus firmly supporting the controller.

18. The artificial intelligence shoes according to claim 17, wherein the controller case comprises a second fitting recess on a bottom thereof, and the controller comprises a second fitting protrusion on a rear surface thereof, so that the second fitting protrusion is fitted into the second fitting recess, thus firmly supporting the controller.

19. The artificial intelligence shoes according to claim 16, wherein the controller comprises terminals and the controller case comprises opposite terminals, the opposite terminals of the controller case being electrically conducted to the walking sensor or the pulse sensor, and the terminals of the controller being electrically connected to the opposite terminals of the controller case to receive signals from the opposite terminals.

20. The artificial intelligence shoes according to claim 2, wherein the controller is detachably attached to any one of a side surface of a midsole of the shoe, an insole of the shoe, a region covering the midsole and an upper of the shoe, a region covering an outsole, the midsole and the upper of the shoe, and a bottom of the outsole of the shoe.

21-31. (canceled)

32. The artificial intelligence shoes according to claim 2, further comprising a weight sensor for automatically sensing a weight of the user or a weight of the shoe.

33. The artificial intelligence shoes according to claim 2, wherein the controller comprises a power cutoff unit for sensing motion of the user and automatically cutting off power of the controller if no motion is sensed, thus preventing consumption of battery power.

34. The artificial intelligence shoes according to claim 2, wherein the display unit of the controller further comprises a backlight unit for emitting light.

35. The artificial intelligence shoes according to claim 8, wherein the input unit of the controller additionally inputs a weight of the user's shoe.

36-40. (canceled)
